(19) United States
(12) Patent Application Publication
(10) Pub. No.: US 2014/0368839 A1
(43) Pub. Date: Dec. 18, 2014

(54) METHOD FOR AUTOMATICALLY ADJUSTING SIZE OF OUTPUT IMAGE OF PRINTER

(71) Applicant: Primax Electronics Ltd., Neihu (TW)

(72) Inventor: Chu Xia, Neihu (TW)

(73) Assignee: Primax Electronics Ltd., Neihu (TW)

(21) Appl. No.: 14/019,178

(22) Filed: Sep. 5, 2013

(30) Foreign Application Priority Data
Jun. 13, 2013 (CN) 201310233939.8

(51) Int. Cl. G06K 15/02

(52) U.S. Cl. CPC G06K 15/1868
USPC 358/1.2

(57) ABSTRACT

A method for automatically adjusting a size of an output image of a printer includes the following steps. Firstly, a default output size of a ready-to-print image is acquired from a page information file of the ready-to-print image. Then, the default output size is compared with the size of a ready-to-print paper on an input tray of the printer. If the default output size does not comply with the size of a ready-to-print paper, an output image with an adjusted size corresponding to the ready-to-print image is generated.

### FIELD OF THE INVENTION

The present invention relates to a method for automatically adjusting a size of an output image of a printer, and more particularly to a method for automatically adjusting a size of an output image of a printer according to a size of a ready-to-print paper on an input tray.

### BACKGROUND OF THE INVENTION

With the increasing development of the information technologies, the popularization of personal computers is accelerated and the markets of the computers and their peripheral devices become more active. Conventionally, a document image stored in a computer may be shown on a display screen, and the document image may be printed on a paper by a printer that is in communication with the computer. For example, the document image may contain the contents of one page or plural pages of an Office file or a PDF file. As the cost of the printer is gradually decreased and the printing performance of the printer is gradually enhanced, the printer has become an indispensable electronic device for an organization or an individual.

Hereinafter, the working processes of a conventional printer and a conventional computer will be illustrated in more details with reference to FIGS. 1 and 2. FIG. 1 is a flowchart illustrating a conventional process of performing a printing job. FIG. 2 is a flowchart illustrating another conventional process of performing a printing job.

Depending on the controlling mechanism, the current printers may be classified into two types, i.e. a PDL printer using a page description language and a GDI printer using a graphical device interface.

In the conventional process of performing the printing job as shown FIG. 1, a PDL printer is employed. When a print file is selected from a computer by a user, the designated print range (also referred as a page range or a designated range) is a so-called ready-to-print image. Once the user decides to perform the printing job, a printing instruction is received by the computer (Step S1). According to the printing instruction, a first page information file indicating the contents of the ready-to-print image and stored in the computer is acquired by the computer.

In practice, when the print file is selected from the computer by the user, the user may previously determine whether the size of the image is adjusted according to the default output size and set the default paper source (also referred as default tray), the default output size and any other information.

In other words, the first page information file indicating the contents of the ready-to-print image may contain the result of determining whether the size of the image is adjusted according to the default output size, the default output size, the character contents, the graphic contents, and the required information about the character and graphic layout and format on the paper. The required information about the character and graphic layout and format on the paper includes for example the character spacing, the line spacing, the font, the font size, and the like.

Before the data are transmitted from the computer to a controller of the printer, the first page information file should be converted into a second page information file using the page description language by the computer (Step S2). The information of the second page information file is substantially identical to the information of the first page information file except that the controller of the printer is able to acquire the contents of the ready-to-print image by interpreting and analyzing the second page information file. After the first page information file is converted into the second page information file, the second page information file is transmitted from the computer to the controller of the printer.

Next, the controller of the printer acquires the contents of the ready-to-print image by interpreting the second page information file, and converts the contents of the ready-to-print image of the second page information file into a bitmap image corresponding to the ready-to-print image (Step S3).

After the bitmap image is generated, a printing unit of the printer may perform the printing job according to the bitmap image. In order to prevent from printing errors caused by the user's setting errors, before the printing job is started, the size of the paper on the default tray of the printer and the size of the bitmap image should be firstly acquired by the controller of the printer (Step S4). Then, the step S5 is performed to judge whether the size of the bitmap image complies with the size of the paper on the default tray in order to prevent a smaller-sized bitmap image from being printed on a larger-sized paper or prevent a larger-sized bitmap image from being printed on a smaller-sized paper. In other words, the step S5 is helpful for reducing the possibility of wasting papers.

If the size of the bitmap image complies with the size of the paper on the default tray, the controller of the printer will directly control the printing unit of the printer to print out the bitmap image on the paper (Step S6).

On the other hand, if the size of the bitmap image does not comply with the size of the paper on the default tray, the printer or the computer will prompt the user to change the settings or change the paper (Step S7).

In the conventional process of performing the printing job as shown FIG. 2, a GDI printer is employed. In comparison with the PDL printer, most procedures of the GDI printer are implemented by the computer. In other words, it is not necessary to transmit the information about the contents of the ready-to-print image from the computer to the printer. Consequently, the computer does not need to convert the first page information file indicating the contents of the ready-to-print image into the second page information file using the page description language, and the printer does not need to convert the second page information file into the bitmap image. After a printing instruction is received by the computer (Step S11), the contents of the ready-to-print image of the first page information file may be converted into a printable bitmap image directly by the computer itself (Step S12).

Then, the size of the paper on the default tray of the printer and the size of the bitmap image are acquired by the computer (Step S13). Then, the step S14 is performed to judge whether the size of the paper on the default tray complies with the size of the bitmap image in order to prevent a smaller-sized bitmap image from being printed on a larger-sized paper or prevent a larger-sized bitmap image from being printed on a smaller-sized paper. In other words, the step S14 is helpful for reducing the possibility of wasting papers.

If the size of the bitmap image complies with the size of the paper on the default tray, the computer will directly transmit the bitmap image to the controller of the printer, and the controller of the printer will control the printing unit of the printer to print out the bitmap image on the paper (Step S15).

On the other hand, if the size of the bitmap image does not comply with the size of the paper on the default tray, either the printer or the computer will prompt the user to change the settings or change the paper (Step S16).

However, the above printers have the following drawbacks. For example, since the size of the bitmap image is unable to be changed, the conventional printer can only request the user to change the settings and then the computer (the GDI printer is used) or the printer (the PDL printer is used) will re-generate the bitmap image according to the new settings. Alternatively, the user may directly change the paper on the default tray according to the size of the bitmap image. As known, both of these two approaches are not user-friendly.

Therefore, there is a need of providing an improved method for automatically adjusting a size of an output image of a printer in order to overcome the above drawbacks.

### SUMMARY OF THE INVENTION

The present invention provides a method for automatically adjusting a size of an output image of a printer without the need of changing the settings or changing the paper by the user.

In accordance with an aspect of the present invention, there is provided a method for automatically adjusting a size of an output image of a printer. The method includes the following steps. In the step (A), a printing instruction is received. In the step (B), a size of a ready-to-print paper on an input tray of the printer and a default output size of a ready-to-print image are acquired. In the step (C), the default output size is compared with the size of the ready-to-print paper. In the (D), if the default output size complies with the size of the ready-to-print paper, a first output image corresponding to the ready-to-print image is generated, wherein the first output image has the default output size. In the (E), if the default output size does not comply with the size of the ready-to-print paper, a second output image corresponding to the ready-to-print image is generated, wherein the second output image has an adjusted size, and the adjusted size is equal to the size of the ready-to-print paper.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a flowchart illustrating a conventional process of performing a printing job;

FIG. 2 is a flowchart illustrating another conventional process of performing a printing job;

FIG. 3 is a flowchart illustrating a method for automatically adjusting a size of an output image of a printer according to a first embodiment of the present invention;

FIG. 4 is a schematic functional block diagram illustrating the architecture of a printer and a host using the method according to the first embodiment of the present invention;

FIG. 5 is a schematic perspective view illustrating the outer appearance of the printer using the method according to the first embodiment of the present invention;

FIG. 6A schematically the operations of a first system using the method according to the first embodiment of the present invention;

FIG. 6B schematically the operations of a second system using the method according to the first embodiment of the present invention;

FIG. 7 is a flowchart illustrating a method for automatically adjusting a size of an output image of a printer according to a second embodiment of the present invention;

FIG. 8 is a schematic functional block diagram illustrating the architecture of a printer and a host using the method according to the second embodiment of the present invention;

FIG. 9A schematically the operations of a first system using the method according to the second embodiment of the present invention; and

FIG. 9B schematically the operations of a second system using the method according to the second embodiment of the present invention.

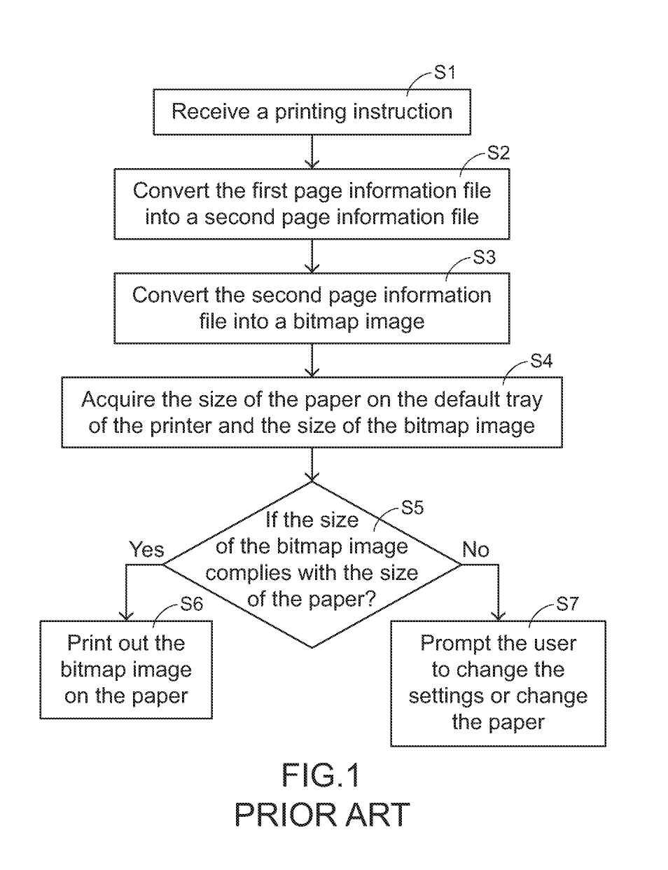

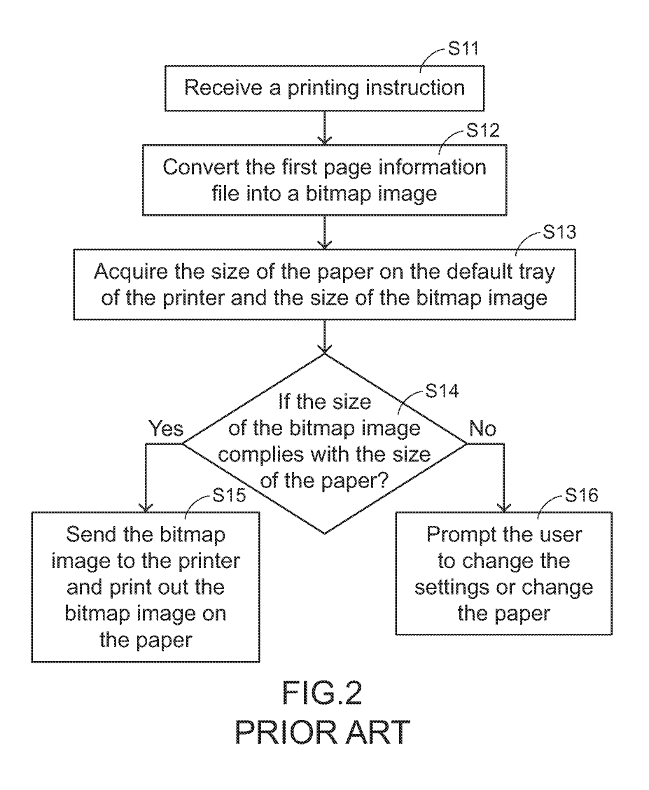

### DETAILED DESCRIPTION OF THE PREFERRED EMBODIMENT

For overcoming the drawbacks of the conventional technology, the present invention provides a method for automatically adjusting a size of an output image corresponding to a ready-to-print image according to a size of a paper on an input tray. The method of the present invention may be executed when a simple print mode of a printer is activated. The detailed operations of the method of the present invention will be illustrated as follows.

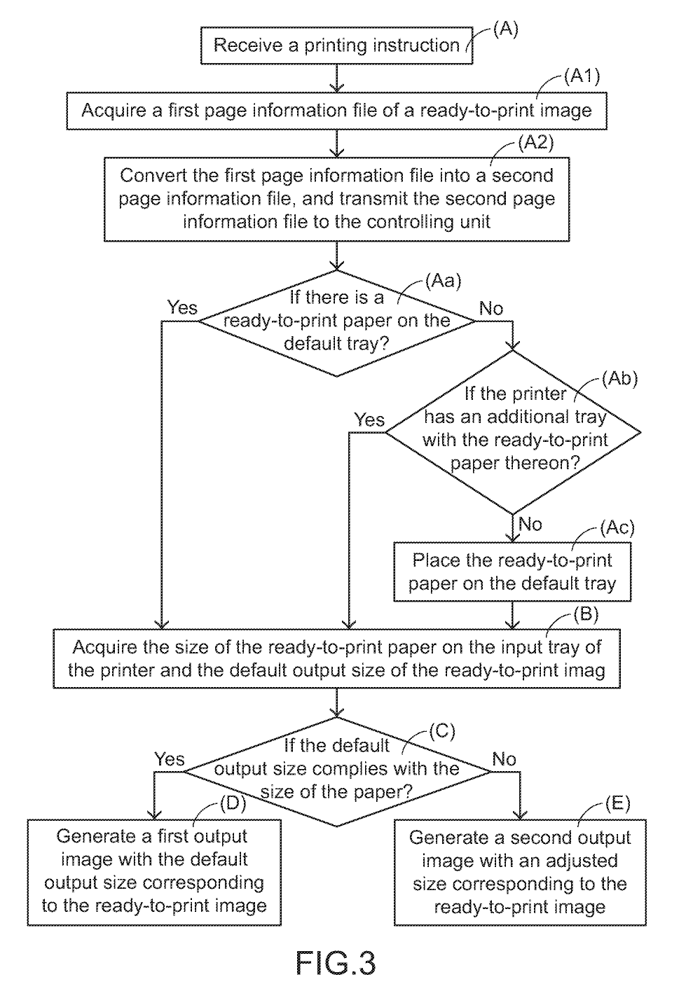

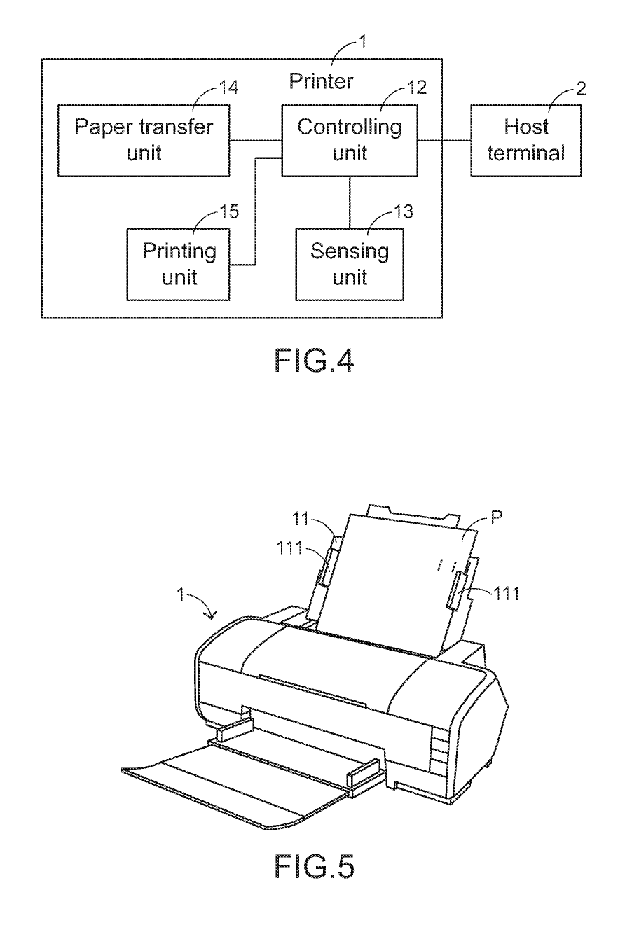

Please refer to FIGS. 3, 4 and 5. FIG. 3 is a flowchart illustrating a method for automatically adjusting a size of an output image of a printer according to a first embodiment of the present invention. FIG. 4 is a schematic functional block diagram illustrating the architecture of a printer and a host using the method according to the first embodiment of the present invention. FIG. 5 is a schematic perspective view illustrating the outer appearance of the printer using the method according to the first embodiment of the present invention. In this embodiment, the printer 1 is a PDL printer using a page description language.

First of all, the printer 1 used in this embodiment will be illustrated. As shown in FIGS. 4 and 5, the printer 1 is in communication with a host terminal 2. The printer 1 comprises a default tray 11, a controlling unit 12, a sensing unit 13, a paper transfer unit 14, and a printing unit 15. The sensing unit 13, the paper transfer unit 14 and the printing unit 15 are all connected with the controlling unit 12, and controlled by the controlling unit 12. The sensing unit 13 is used for detecting whether there is any paper on the default tray 11 and detecting a size of the paper on the default tray 11.

It is noted that there are many ways of detecting the size of the paper. The way of detecting the size of the paper as shown in FIG. 5 is presented herein for purpose of illustration and description only. In this embodiment, after the paper is placed on the default tray 11 and a left sliding block 111 and a right sliding block 111 are moved to be respectively contacted with two parallel edges of the paper, the sensing unit 13 may realize the size of the paper according to the positions of the sliding blocks 111 and send the information about the size of the paper to the controlling unit 12.

Moreover, the way of detecting whether there is any paper on the default tray 11 is not restricted. For example, in an embodiment, a photo interrupter (not shown) is disposed on the default tray 11. In case that any paper is placed on the default tray 11, a light beam emitted from a transmitter terminal of the photo interrupter is interrupted by the paper. Consequently, the sensing unit 13 can realize that there is any paper on the default tray 11.

Alternatively, the function of detecting the size of the paper may be achieved without the need of installing the sliding blocks 111 or other similar components on the printer 1. Under this circumstance, by directly inputting the size of the paper through a control panel (not shown) or a button (not shown) of the printer, the information about the inputted size of the paper can be transmitted to the controlling unit 12.

A method for automatically adjusting a size of an output image of a printer according to the first embodiment of the present invention will be illustrated as follows.

In the step (A), a printing instruction is received.

In the step (A1), a first page information file of a ready-to-print image is acquired.

In the step (A2), the first page information file is converted into a second page information file, and the second page information file is transmitted to the controlling unit.

The step (Aa) is performed to judge whether there is a ready-to-print paper on the default tray. If the judging condition of the step (Aa) is satisfied, the steps (B) to (E) are selectively performed. On the other hand, if the judging condition of the step (Aa) is not satisfied, the step (Ab) is performed.

The step (Ab) is performed to judge whether the printer has an additional tray with the ready-to-print paper thereon. If the judging condition of the step (Ab) is satisfied, the steps (B) to (E) are selectively performed. On the other hand, if the judging condition of the step (Ab) is not satisfied, the step (Ac) is performed.

In the step (Ac), the ready-to-print paper is placed on the default tray. After the step (Ac), the steps (B) to (E) are selectively performed.

The above steps will be illustrated in more details as follows.

First of all, when the user wants to select and print a document (e.g. one page or plural pages of an Office file or a PDF file) from the host terminal 2, the user may previously set the print range (also referred as a page range or a designated range), the default paper source, the default output size and any other information. The designated print range is the so-called ready-to-print image. In this embodiment, the default paper source is the default tray 11. Once the user decides to perform the printing job, a printing instruction is received by the host terminal 2 (e.g. in the step A). According to the printing instruction, a first page information file F1 indicating the contents of the ready-to-print image and stored in the host terminal 2 is acquired by the host terminal 2 (e.g. in the step A1). The contents of the ready-to-print image at least contain the information about the default output size of the ready-to-print image. In addition, the contents of the ready-to-print image may also contain the character contents of the ready-to-print image, the graphic contents of the ready-to-print image, and the required information about the character and graphic layout and format on the paper. The required information about the character and graphic layout and format on the paper includes for example the character spacing, the line spacing, the font, the font size, and the like.

As mentioned above, since the printer 1 is a PDL printer, most procedures of the printer 1 are implemented by the controlling unit 12 of the printer 1. After the contents of the ready-to-print image are acquired from the host terminal 2, it is necessary to transmit the contents of the ready-to-print image to the controlling unit 12 of the printer 1. For allowing the controlling unit 12 to interpret and analyze the contents of the ready-to-print image, the first page information file F1 indicating the contents of the ready-to-print image should be converted into a second page information file F2 using the page description language by the host terminal 2. After the first page information file F1 is converted into the second page information file F2, the second page information file F2 is transmitted from the host terminal 2 to the controlling unit 12 of the printer 1 (e.g. in the step A2).

The information of the second page information file F2 is substantially identical to the information of the first page information file F1 except that the controlling unit 12 of the printer 1 is able to acquire the contents of the ready-to-print image by interpreting and analyzing the second page information file F2.

However, if no paper is placed on the default paper source according to the user's settings (i.e. the default tray 11), printing errors are possibly generated. For preventing from the printing errors, the step Aa will be performed to judge whether there is a ready-to-print paper on the default tray after the second page information file F2 is received by the controlling unit 12 of the printer 1. In this embodiment as shown in FIG. 5, a first paper P is placed on the default tray 11. Consequently, the controlling unit 12 judges that the ready-to-print paper is placed on the default tray and the printing job can be continuously performed. Accordingly, the steps (B) to (E) are selectively performed by the controlling unit 12. In this embodiment, the input tray is the default tray 11, and the ready-to-print paper is the first paper P on the default tray 11.

The steps (B) to (E) of the method for automatically adjusting the size of the output image of the printer according to the first embodiment of the present invention will be illustrated as follows.

In the step (B), the size of the ready-to-print paper on the input tray of the printer and the default output size of the ready-to-print image acquired.

In the step (C), the default output size is compared with the size of the ready-to-print paper.

In the step (D), if the default output size complies with the size of the ready-to-print paper, a first output image with the default output size corresponding to the ready-to-print image is generated.

In the step (E), if the default output size does not comply with the size of the ready-to-print paper, a second output image with an adjusted size corresponding to the ready-to-print image is generated.

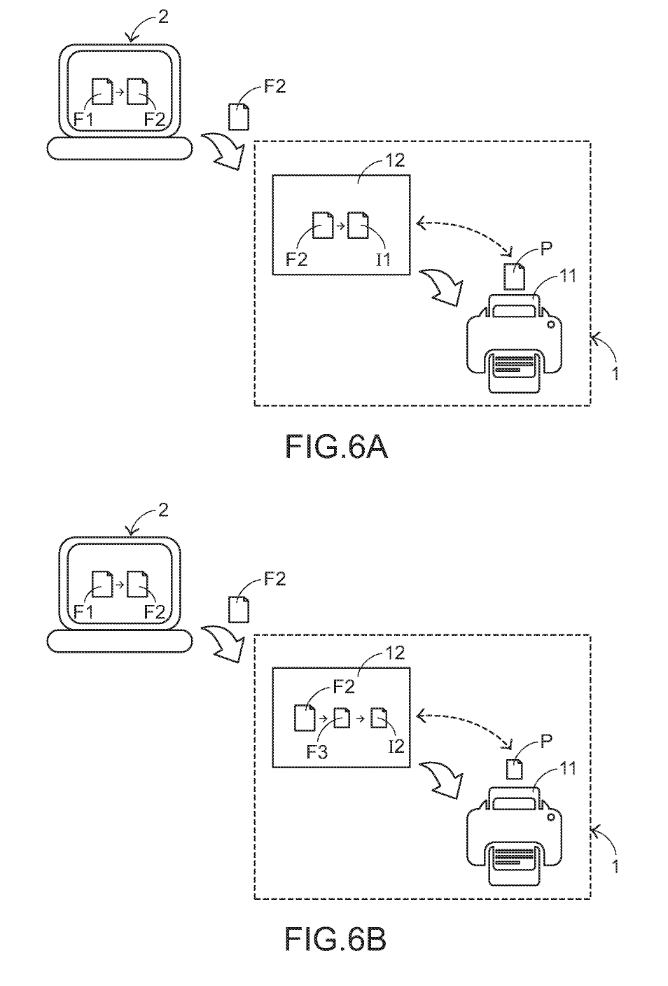

The above steps will be illustrated in more details as follows. Please refer to FIGS. 3, 4, 6A and 6B. FIG. 6A schematically the operations of a first system using the method according to the first embodiment of the present invention. FIG. 6B schematically the operations of a second system using the method according to the first embodiment of the present invention.

First of all, if the contents of the ready-to-print image of the second page information file F2 are converted into an output image, the output image has the default output size, and the output image is a bitmap image that cannot be scaled up or scaled down. For avoiding mismatch between the size of the output image to be printed on the first paper P and the size of the first paper P, after the second page information file F2 is received by the controlling unit 12, the controlling unit 12 should compare the size of the first paper P on the default tray 11 with the default output size of the ready-to-print image to judge whether both of them comply with each other or not. As shown in the step B, the controlling unit 12 will acquire the default output size of the ready-to-print image from the contents of the ready-to-print image of the second page information file F2, and acquire the information about the size of the first paper P on the default tray 11 from the sensing unit 13.

Next, in the step (C), the controlling unit 12 judges whether the default output size complies with the size of the first paper P or not. If the default output size complies with the size of the first paper P (see FIG. 6A), it means that the second page information file F2 does not need to be modified. Consequently, the controlling unit 12 performs the step (D) to convert the contents of the ready-to-print image of the second page information file F2 into the first output image I1 corresponding to the ready-to-print image. As mentioned above, the first output image I1 has the default output size identical to the size of the first paper P. Consequently, the first output image I1 can be accurately printed on the first paper P, wherein the first output image I1 is a bitmap image.

If the default output size does not comply with the size of the first paper P, the output image obtained by directly converting the second page information file F2 does not match the size of the first paper P. Under this circumstance, the output image is inaccurately printed, and thus the second page information file F2 needs to be modified in advance.

In other words, if the default output size does not comply with the size of the first paper P (see FIG. 6B), the controlling unit 12 performs the step (E) to modify the second page information file F2 as an adjusted page information file F3. In particular, the controlling unit 12 needs to modify the default output size of the second page information file F2 as an adjusted size, which is equal to the size of the first paper P. Moreover, the controlling unit 12 will modify the required information about the character and graphic layout and format of the ready-to-print image on the paper according to the adjusted size. Consequently, the adjusted page information file F3 contains the information about adjusted size, the adjusted character and graphic layout, and the adjusted format.

Consequently, after the contents of the ready-to-print image of the adjusted page information file F3 are converted into the second output image I2 corresponding to the ready-to-print image by the controlling unit 12, the second output image I2 has the adjusted size identical to the size of the first paper P. Consequently, the second output image I2 can be accurately printed on the first paper P, wherein the second output image I2 is a bitmap image.

Then, the controlling unit 12 controls the printer 1 to print the first output image I1 or the second output image I2 on the first paper P. In particular, the controlling unit 12 controls the paper transfer unit 14 to transport the first paper P through the printing unit 15, and controls the printing unit 15 to print the first output image I1 or the second output image I2 on the first paper P. It is noted that the printing unit 15 is an inkjet printing unit or a laser printing unit. The structures and operating principles of the inkjet printing unit and the laser printing unit are well known in the art, and are not redundantly described herein.

Please refer to FIG. 3 again. If the first paper P is not placed on the default tray 11 (e.g. in the step Aa), the controlling unit 12 may realize that the ready-to-print paper is not placed on the default tray, and then judge that no paper can be printed. Under this circumstance, the printing job is suspended, and then the step Ab is performed to judge whether the printer 1 has an additional tray with the ready-to-print paper thereon.

In this embodiment as shown in FIG. 5, the printer 1 does not have any other tray. That is, if there is not any ready-to-print paper on the default tray 11, the printer 1 has no paper to be continuously printed. Under this circumstance, the controlling unit 12 may allow the printer 1 to show an error message. The error message may notify the user of placing the ready-to-print paper on the default tray 11. Consequently, the printing job can be continuously performed.

After the ready-to-print paper is placed on the default tray 11 (e.g. in the step Ac), the controlling unit 12 may realize that the ready-to-print paper is on the default tray 11 and the printing job can be performed according to the detecting result of the sensing unit 13. Consequently, the controlling unit 12 will continuously perform the steps (B) to (E). Meanwhile, the input tray is the default tray 11.

On the other hand, if the printer 1 has an additional tray with the ready-to-print paper thereon (e.g. in the step Ab), the controlling unit 12 will judge that the ready-to-print paper on the additional tray can be subjected to the printing job. Consequently, the controlling unit 12 will continuously perform the steps (B) to (E). Meanwhile, the input tray is the additional tray that the ready-to-print paper is placed thereon.

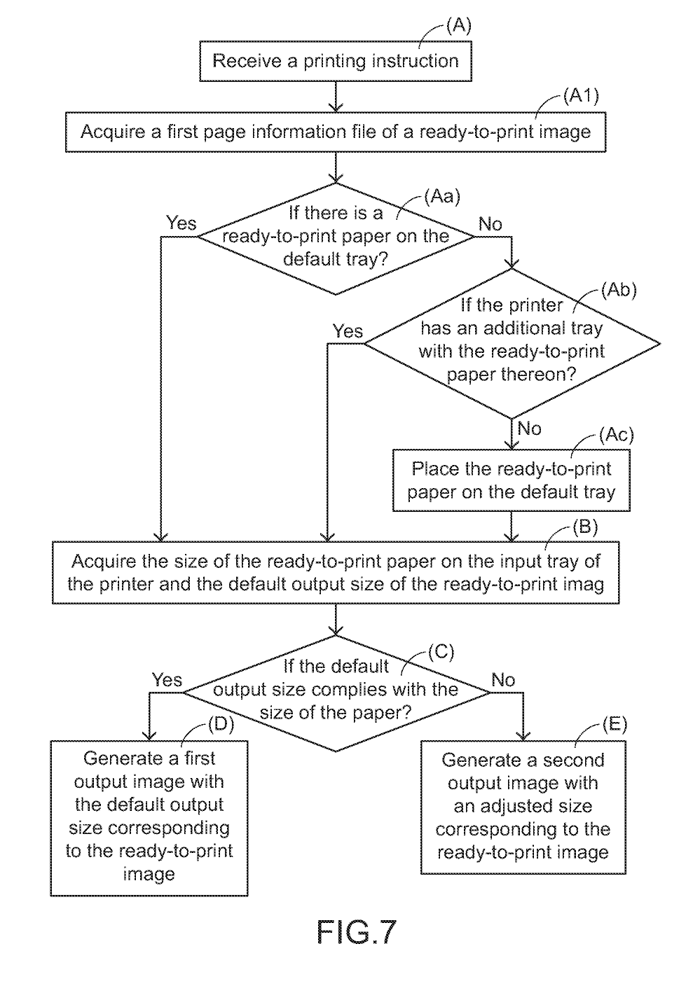

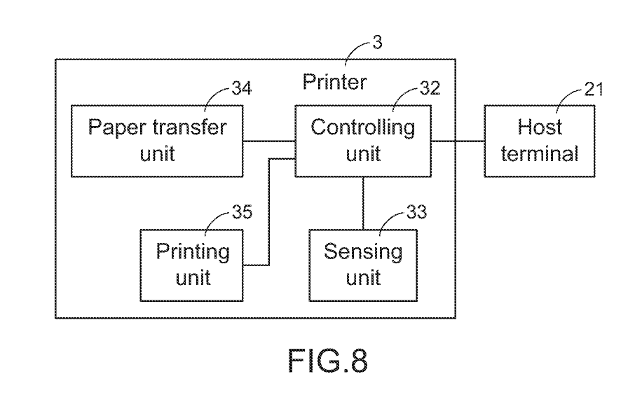

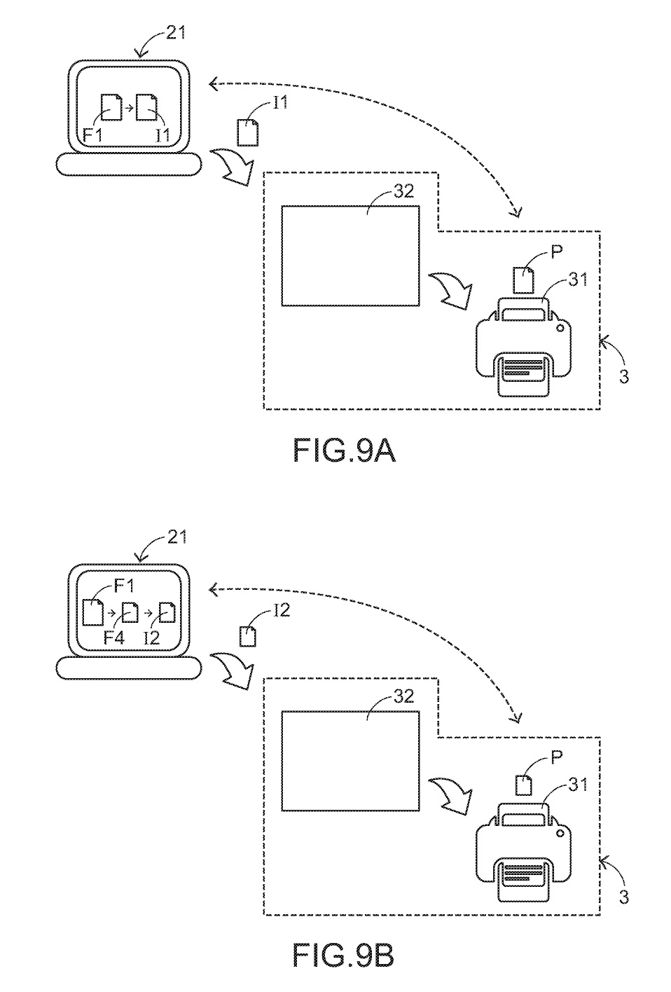

Hereinafter, a method for automatically adjusting a size of an output image of a printer according to a second embodiment of the present invention will be illustrated with reference to FIGS. 7, 8, 9A and 9B. FIG. 7 is a flowchart illustrating a method for automatically adjusting a size of an output image of a printer according to a second embodiment of the present invention. FIG. 8 is a schematic functional block diagram illustrating the architecture of a printer and a host using the method according to the second embodiment of the present invention. FIG. 9A schematically the operations of a first system using the method according to the second embodiment of the present invention. FIG. 9B schematically the operations of a second system using the method according to the second embodiment of the present invention. In this embodiment, the printer 3 is a GDI printer using a graphical device interface.

First of all, the printer 3 used in this embodiment will be illustrated. The printer 3 is in communication with a host terminal 21. The printer 3 comprises a default tray 31, a controlling unit 32, a sensing unit 33, a paper transfer unit 34, and a printing unit 35. The sensing unit 33 is used for detecting whether there is any paper on the default tray 31 and detecting the size of the paper on the default tray 31. The controlling unit 32 is used for controlling the paper transfer unit 34 and the printing unit 35, and transmitting the detecting result of the sensing unit 33 to the host terminal 21.

It is noted that the printer 3 may not have the function of detecting the size of the paper on the default tray 31. Under this circumstance, by directly inputting the size of the paper through a control panel (not shown) or a button (not shown) of the printer, the information about the inputted size of the paper can be transmitted to the controlling unit 32.

A method for automatically adjusting a size of an output image of a printer according to the second embodiment of the present invention will be illustrated as follows.

In the step (A), a printing instruction is received.

In the step (A1), a first page information file of a ready-to-print image is acquired.

The step (Aa) is performed to judge whether there is a ready-to-print paper on the default tray. If the judging condition of the step (Aa) is satisfied, the steps (B) to (E) are selectively performed. On the other hand, if the judging condition of the step (Aa) is not satisfied, the step (Ab) is performed.

The step (Ab) is performed to judge whether the printer has an additional tray with the ready-to-print paper thereon. If the judging condition of the step (Ab) is satisfied, the steps (B) to (E) are selectively performed. On the other hand, if the judging condition of the step (Ab) is not satisfied, the step (Ac) is performed.

In the step (Ac), the ready-to-print paper is placed on the default tray. After the step (Ac), the steps (B) to (E) are selectively performed.

The above steps will be illustrated in more details as follows.

As mentioned above, when the GDI printer is employed, most procedures are implemented by the host terminal 21. In comparison with the method of the first embodiment, the steps (A) to (E) of the method of this embodiment are all implemented by the host terminal 21, and the method of this embodiment does not include the step (A2), which will be illustrated as follows.

When the user wants to select and print a document from the host terminal, the user may previously set the print range, the default paper source and the default output size. The designated print range is also referred as the ready-to-print image. In this embodiment, the default paper source is the default tray 31. Once the user decides to perform the printing job, a printing instruction is received by the host terminal 21 (e.g. in the step A).

According to the printing instruction, a first page information file F1 indicating the contents of the ready-to-print image and stored in the host terminal 21 is acquired from the host terminal 21 (e.g. in the step A1). Since the following procedures are all implemented by the host terminal 21, it is not necessary for the printer 3 to interpret and analyze the contents of the ready-to-print image. In this embodiment, it is not necessary to convert the first page information file F1 into the second page information file F2, which is the essential step of the first embodiment.

However, if no paper is placed on the default paper source according to the user's settings (i.e. the default tray 31), printing errors are possibly generated. For preventing from printing errors, the step Aa will be performed to judge whether there is a ready-to-print paper on the default tray after the first page information file F1 is received by the host terminal 21. In this embodiment, a first paper P is placed on the default tray 31. Consequently, the host terminal 21 judges that the printing job can be continuously performed. Accordingly, the steps (B) to (E) are selectively performed by the controlling unit 12. In this embodiment, the input tray is the default tray 31, and the ready-to-print paper is the first paper P on the default tray 31. Except that the steps (B) to (E) of the method of this embodiment are implemented by the host terminal 21, the steps (B) to (E) of the method of this embodiment are substantially identical to those of the method of the first embodiment, and are not redundantly described herein.

Then, according to the size of the first paper P, the host terminal 21 converts the first page information file F1 into the first output image I1 (see FIG. 9A) or converts the adjusted page information file F4 into the second output image I2. Then, the first output image I1 or the second output image I2 is transmitted to the controlling unit 32 of the printer 3. After the first output image I1 or the second output image I2 is received by the controlling unit 32, the controlling unit 32 controls the paper transfer unit 34 to transport the first paper P through the printing unit 35, and controls the printing unit 35 to print the first output image I1 or the second output image I2 on the first paper P.

Moreover, if the first paper P is not placed on the default tray 31, the step (Ab) and the step (Ac) are performed. The step (Ab) and the step (Ac) are similar to those of the first embodiment, and are not redundantly described herein.

From the above descriptions, the present invention provides a method for automatically adjusting a size of an output image of a printer. Before the page information file is converted into the bitmap image, the default output size of the ready-to-print image of the page information file and the size of the ready-to-print paper on the input tray are acquired and compared with each other. If the default output size does not comply with the size of the ready-to-print paper, the page information file is modified, and then the adjusted page information file is converted into the bitmap image.

Consequently, if the printer of the present invention results in mismatch between the size of the output image and the size of the ready-to-print paper on the input tray because of user's setting errors, it is not necessary for the user to change the settings or change the paper. Since the size of the output image can be automatically adjusted, the method of the present invention is more user-friendly when compared with the conventional method of operating the printer.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for automatically adjusting a size of an output image of a printer, said method comprising steps of:
(A) receiving a printing instruction;
(B) acquiring a size of a ready-to-print paper on an input tray of said printer and a default output size of a ready-to-print image;
(C) comparing said default output size with said size of said ready-to-print paper;
(D) if said default output size complies with said size of said ready-to-print paper, generating a first output image corresponding to said ready-to-print image, wherein said first output image has said default output size; and
(E) if said default output size does not comply with said size of said ready-to-print paper, generating a second output image corresponding to said ready-to-print image, wherein said second output image has an adjusted size, and said adjusted size is equal to said size of said ready-to-print paper.

2. The method according to claim 1, wherein said printer is a GDI printer, and said printer is in communication with a host terminal, wherein said printer comprises said input tray and a controlling unit.

3. The method according to claim 2, wherein said steps (A) to (E) are implemented by said host terminal, wherein in said step (B), said size of said ready-to-print paper is transmitted from said controlling unit to said host terminal.

4. The method according to claim 3, wherein between said step (B) and said step (A), said method further comprises a step (A1) of acquiring a first page information file of said ready-to-print image, wherein said default output size is stored in said first page information file, and said step (A1) is implemented by said host terminal.

5. The method according to claim 4, wherein in said step (D), said first output image is generated by converting said first page information file into said first output image, wherein in said step (E), said second output image is generated by modifying said first page information file as an adjusted page information file, and said adjusted size is stored in said adjusted page information file.

6. The method according to claim 1, wherein said printer is a PDL printer, and said printer is in communication with a host terminal, wherein said printer comprises said input tray and a controlling unit.

7. The method according to claim 6, wherein said steps (B) to (E) are implemented by said controlling unit, and said step (A) is implemented by said host terminal.

8. The method according to claim 7, wherein between said step (B) and said step (A), said method further comprises steps of:
(A1) acquiring a first page information file of said ready-to-print image; and
(A2) converting said first page information file into a second page information file, and transmitting said second page information file to said controlling unit,
wherein said default output size is stored in said first page information file and said second page information file, and said step (A1) and said step (A2) are implemented by said host terminal.

9. The method according to claim 8, wherein in said step (D), said first output image is generated by converting said second page information file into said first output image, wherein in said step (E), said second output image is generated by modifying said first page information file as an adjusted page information file, and said adjusted size is stored in said adjusted page information file.

10. The method according to claim 1, wherein said printer comprises said input tray, a printing unit, a paper transfer unit and a controlling unit, wherein said controlling unit is connected with said printing unit and said paper transfer unit.

11. The method according to claim 1, wherein said printer further comprises a sensing unit for detecting said size of said ready-to-print paper and detecting whether said ready-to-print paper is placed on said input tray.

12. The method according to claim 1, wherein said first output image and said second output image are bitmap images.

13. The method according to claim 1, wherein between said step (B) and said step (A), said method further comprises steps of:
(Aa) judging whether said ready-to-print paper is placed on a default tray, wherein if said ready-to-print paper is placed on a default tray, said steps (B) to (E) are selectively performed, wherein if said ready-to-print paper is placed on said default tray, said input tray is said default tray;
(Ab) if said ready-to-print paper is not placed on said default tray, judging whether said printer has an additional tray with said ready-to-print paper thereon, wherein if said printer has said additional tray with said ready-to-print paper thereon, said steps (B) to (E) are selectively performed, wherein if said printer has said additional tray with said ready-to-print paper thereon, said input tray is said additional tray; and
(Ac) if said printer does not have said additional tray with said ready-to-print paper thereon, placing said ready-to-print paper on said default tray and performing said steps (B) to (E), wherein if said ready-to-print paper is not placed on said additional tray of said printer, said input tray is said default tray.
